(19) United States
(12) Patent Application Publication
(10) Pub. No.: US 2018/0153133 A1
(43) Pub. Date: Jun. 7, 2018

(54) Feline Housing Assembly

(71) Applicant: Celeste Lewis-Linde, Gary, IN (US)

(72) Inventor: Celeste Lewis-Linde, Gary, IN (US)

(21) Appl. No.: 15/371,733

(22) Filed: Dec. 7, 2016

(51) Int. Cl. A01K 1/03

(52) U.S. Cl. CPC A01K 1/033

(57) ABSTRACT

A feline housing assembly includes a box that may be placed outdoors. A doorway extends into an interior of the box. Thus, a feral cat may enter the box thereby facilitating the feral cat to stay warm. The box includes a plurality of first flaps. Each of the first flaps is movably coupled to the box. The first flaps are selectively interlaced into a closed position to form a floor on the box. The box includes a plurality of second flaps and each of the second flaps is movably coupled to the box. The second flaps are selectively interlaced into a closed position such to form a roof on the box. A panel is selectively positioned within the box to enhance a load bearing capacity of the box.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to housing devices and more particularly pertains to a new housing device for housing feral cats.

### BRIEF SUMMARY OF THE INVENTION

An embodiment of the disclosure meets the needs presented above by generally comprising a box that may be placed outdoors. A doorway extends into an interior of the box. Thus, a feral cat may enter the box thereby facilitating the feral cat to stay warm. The box includes a plurality of first flaps. Each of the first flaps is movably coupled to the box. The first flaps are selectively interlaced into a closed position to form a floor on the box. The box includes a plurality of second flaps and each of the second flaps is movably coupled to the box. The second flaps are selectively interlaced into a closed position such to form a roof on the box. A panel is selectively positioned within the box to enhance a load bearing capacity of the box.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a feline housing assembly according to an embodiment of the disclosure.

FIG. 2 is a front view of an embodiment of the disclosure.

FIG. 3 is a bottom phantom view of an embodiment of the disclosure.

FIG. 4 is an exploded perspective view of an embodiment of the disclosure.

FIG. 5 is a cross sectional view taken along line 5-5 of FIG. 2 of an embodiment of the disclosure.

### DETAILED DESCRIPTION OF THE INVENTION

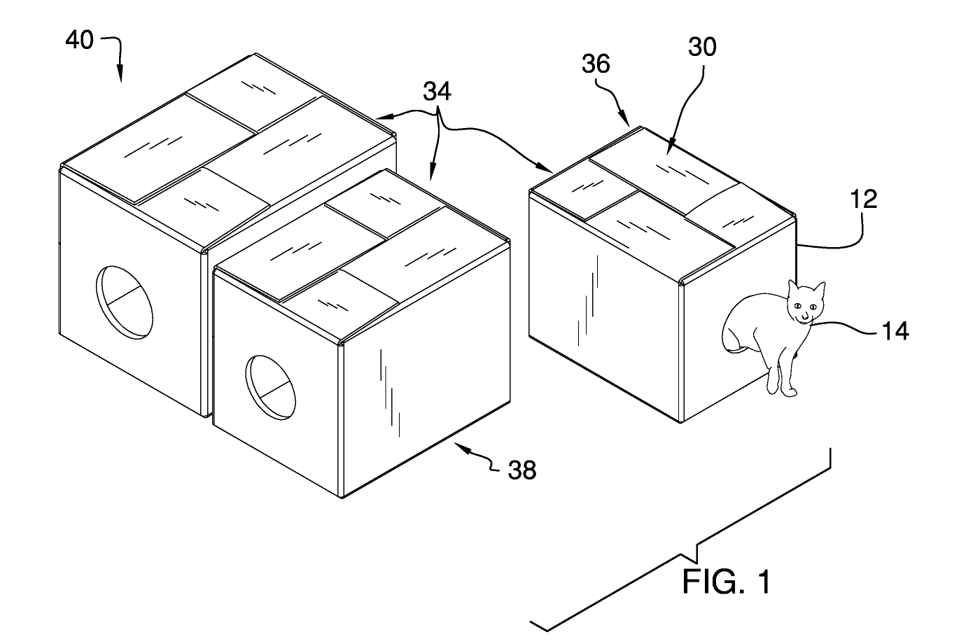

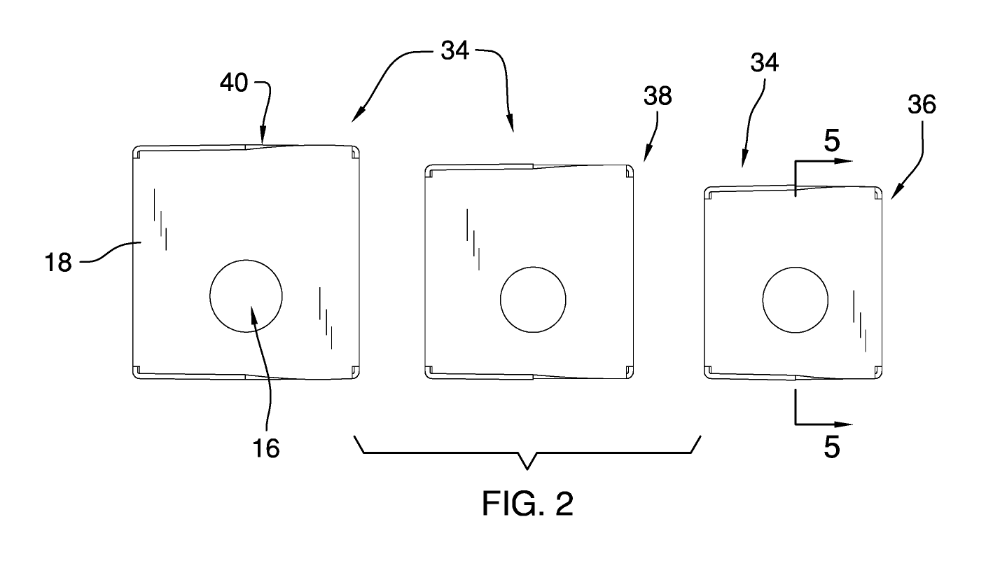

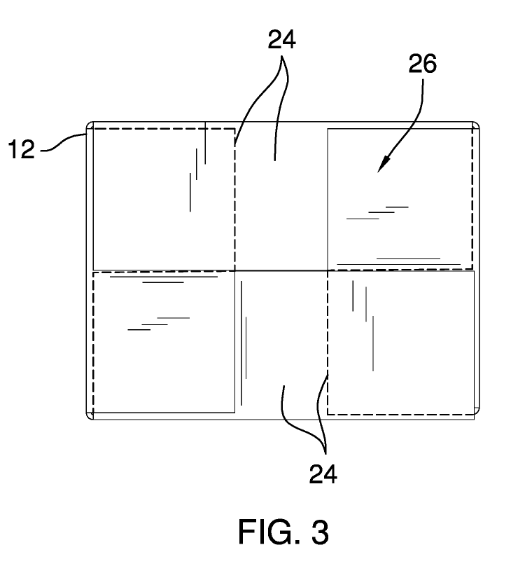

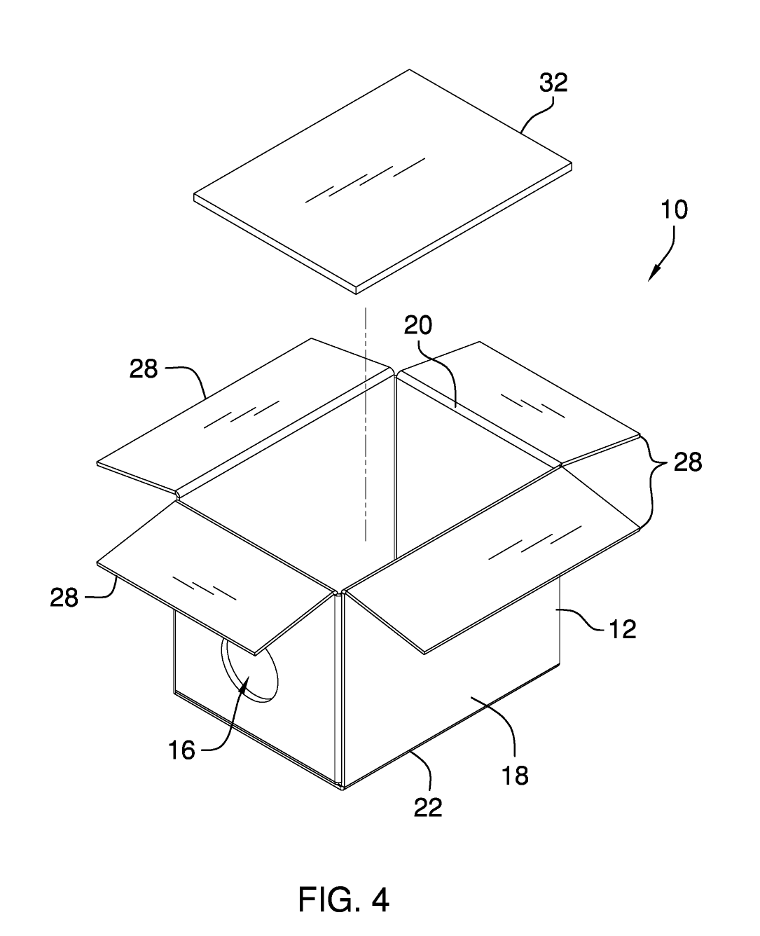

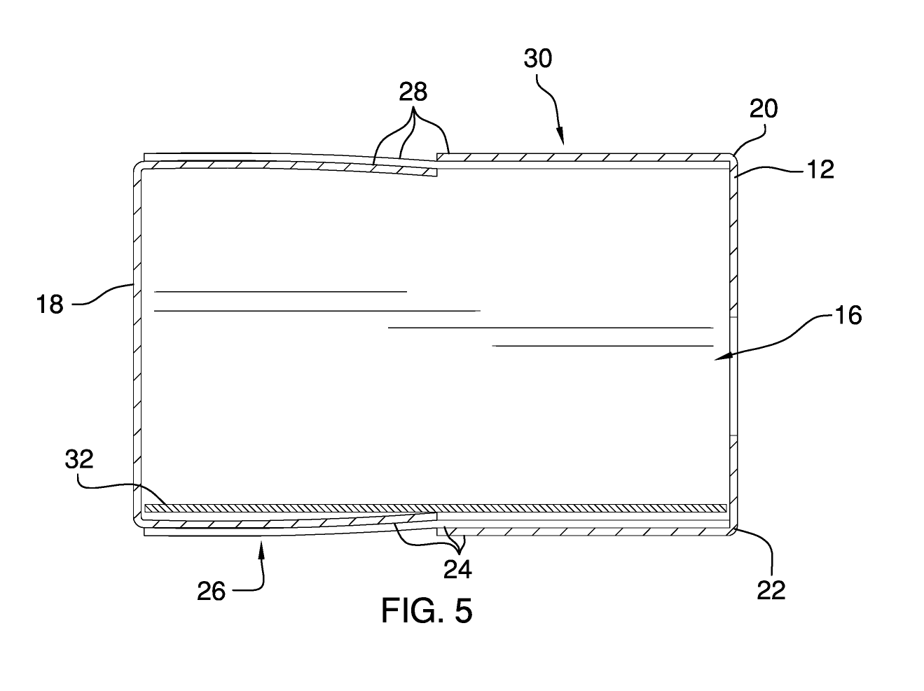

With reference now to the drawings, and in particular to FIGS. 1 through 5 thereof, a new housing device embodying the principles and concepts of an embodiment of the disclosure and generally designated by the reference numeral 10 will be described.

As best illustrated in FIGS. 1 through 5, the feline housing assembly 10 generally comprises a box 12 that may be placed outdoors. The box 12 is positioned in a location known to be occupied by one or more feral cats 14. The box 12 has a doorway 16 extending into an interior of the box 12. Moreover, the feral cat 14 may enter the doorway 16 thereby facilitating the feral cat 14 to stay warm.

The box 12 has a peripheral wall 18. The outer wall has a top edge 20 and a bottom edge 22. The doorway 16 is positioned on the peripheral wall 18 and the doorway 16 may have a circular shape. The box 12 is comprised of a biodegradable material such as cardboard or the like.

The box 12 includes a plurality of first flaps 24. Each of the first flaps 24 is movably coupled to the box 12. The first flaps 24 are selectively interlaced into a closed position. Thus, the plurality of first flaps 24 forms a floor 26 on the box 12. Each of the first flaps 24 is positioned on the bottom edge 22 of the box 12. Moreover, the first flaps 24 are spaced apart from each other and are distributed around the bottom edge 22.

A plurality of second flaps 28 is provided and each of the second flaps 28 is movably coupled to the box 12. The second flaps 28 are selectively interlaced into a closed position. Thus, the plurality of second flaps 28 forms a roof 30 of the box 12. Each of the second flaps 28 is positioned on the top edge 20 of the box 12. The second flaps 28 are spaced apart from each other and are distributed around the top edge 20.

A panel 32 is selectively positioned within the box 12. The panel 32 is enhances a load bearing capacity of the box 12. The panel 32 is positioned on the floor 26. Moreover, the panel 32 completely covers the floor 26. The panel 32 inhibits a weight of the feral cat 14 from urging the second flaps 28 into an open position.

A plurality of the boxes 34 may be provided to house a plurality of feral cats 14. The plurality of boxes 34 may include a small box 36, a medium box 38 and a large box 40. Thus, the plurality of boxes 34 may accommodate a variety of sizes of feral cats 14.

In use, the panel 32 is positioned in the box 12 and each of the first flaps 24 and the second flaps 28 are interlaced into the respective closed positions. The box 12 is oriented such that the floor 26 lies on the ground. Thus, the panel 32 rests on the floor 26. The box 12 is positioned in the area known to be occupied by the feral cats 14. The feral cats 14 enter the box 12 to seek shelter during cold or rainy weather. Moreover, the box 12 degrades over time thereby enhancing environmental conservation.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A feline housing assembly being configured to be placed outdoors thereby facilitating shelter for feral cats, said assembly comprising:
a box being configured to be placed outdoors, said box having a doorway extending into an interior of said box wherein said doorway is configured to facilitate a feral cat to enter said box thereby facilitating the feral cat to stay warm;
a plurality of first flaps, each of said first flaps being movably coupled to said box, said first flaps being selectively interlaced into a closed position such that said plurality of flaps forms a floor on said box;
a plurality of second flaps, each of said second flaps being movably coupled to said box, said second flaps being selectively interlaced into a closed position such that said plurality of flaps forms a roof on said box; and
a panel being selectively positioned within said box wherein said panel is configured to enhance a load bearing capacity of said box.

2. The assembly according to claim 1, wherein the box has a peripheral wall, said peripheral wall having a top edge and a bottom edge, said doorway being positioned on said outer wall.

3. The assembly according to claim 2, wherein each of said first flaps is positioned on said bottom edge of said box, said first flaps being spaced apart from each other and being distributed around said bottom edge.

4. The assembly according to claim 2, wherein each of said second flaps is positioned on said top edge of said box, said second flaps being spaced apart from each other and being distributed around said top edge.

5. The assembly according to claim 2, wherein said panel is positioned on said floor, said panel completely covering said bottom wall wherein said panel is configured to support the feral cat.

6. A feline housing assembly being configured to be placed outdoors thereby facilitating shelter for feral cats, said assembly comprising:
a box being configured to be placed outdoors, said box having a doorway extending into an interior of said box wherein said doorway is configured to facilitate a feral cat to enter said box thereby facilitating the feral cat to stay warm, said box having a peripheral wall, said peripheral wall having a top edge and a bottom edge, said doorway being positioned on said outer wall;
a plurality of first flaps, each of said first flaps being movably coupled to said box, said first flaps being selectively interlaced into a closed position such that said plurality of first flaps forms a floor of said box, each of said first flaps being positioned on said bottom edge of said box, said first flaps being spaced apart from each other and being distributed around said bottom edge; and
a plurality of second flaps, each of said second flaps being movably coupled to said box, said second flaps being selectively interlaced into a closed position such that said plurality of second flaps forms a roof of said box, each of said second flaps being positioned on said top edge of said box, said second flaps being spaced apart from each other and being distributed around said top edge;
a panel being selectively positioned within said box wherein said panel is configured to enhance a load bearing capacity of said box, said panel being positioned on said floor, said panel completely covering said floor wherein said panel is configured to support the feral cat.
